(19) United States
(12) Patent Application Publication
(10) Pub. No.: US 2004/0161543 A1
(43) Pub. Date: Aug. 19, 2004

(54) Method of drying liquid coating composition

(76) Inventors: Kazuhiko Nojo, Fujinomiya-shi (JP); Harumichi Inoue, Odawara-shi (JP)

Correspondence Address: BIRCH STEWART KOLASCH & BIRCH, PO BOX 747, FALLS CHURCH, VA, 22040-0747, US

(21) Appl. No.: 10/775,248

(22) Filed: Feb. 11, 2004

(30) Foreign Application Priority Data
Feb. 12, 2003 (JP) 2003-033796

(51) Int. Cl. B05D 3/02

(52) U.S. Cl. 427/385.5; 427/557

(57) ABSTRACT

A method comprising: drying a liquid coating composition containing a volatile solvent and a binder coated to a base film containing cellulose triacetate, wherein drying of the coated base film is started within 10 seconds from coating, and a residual solvent content of the coating is reduced to 30% or less based on the binder within 30 seconds from coating.

### FIELD OF THE INVENTION

This invention relates to a method of drying a liquid coating composition applied to a base film containing cellulose triacetate. The method is contemplated particularly to provide a uniform coating film on such base film.

### BACKGROUND OF THE INVENTION

A coating composition can be applied to a base film by various coating techniques including gravure coating, roll coating, bar coating, and extrusion coating. A coating composition applied to a base film by any coating technique is dried, either spontaneously or by heat coating or air blowing, thereby to be fixed onto the base film, as typically described in JP-B-2-58554 (U.S. Pat. No. 4,365,423).

It is known that a base film containing cellulose triacetate (hereinafter “CTA”), when coated with a composition containing an organic solvent such as methyl ethyl ketone (hereinafter “MEK”), generally allows the organic solvent to penetrate therein. In practice, however, an organic solvent-containing coating composition applied on a CTA-containing base film has often been dried in the same manner as on other substrates such as a polyethylene terephthalate (PET) base film.

Where an organic solvent-borne coating composition based on a mixed solvent containing MEK is applied to a CTA substrate, MEK is selectively allowed to penetrate into the substrate. In general, the final appearance and properties of a coated surface are affected by whether the coating is dried immediately after coating or slowly after coating. For instance, when a coating composition prepared by dissolving a binder (e.g., an acrylic resin) in an MEK-containing mixed solvent and dispersing fine particles in the solution is applied to a CTA base and dried rapidly, there is formed a film in which both the binder and the fine particles are distributed almost uniformly in the film thickness direction. The resulting film exhibits desired strength and suffers from little surface roughness ascribable to the fine particles exposed on the surface. On the other hand, if a coating film is blown with strong drying air or heated at an increased temperature immediately after coating in an attempt to dry rapidly, the strong air can disturb the coating, or the heat can evaporate the solvent so rapidly as to roughen the coating surface. It would follow that the dried film suffers from thickness variation or visual unevenness. Moreover, instantaneous latent heat of evaporation drops the temperature of the coating applied on the CTA base, which can cause moisture in drying air to be condensed and make the surface cloudy.

Where in contrast the coating is dried slowly after coating, the acrylic binder dissolved in MEK moves toward the CTA base, accompanying MEK that is penetrating into the CTA base, and can penetrate into the base. It follows that the coating film has a lower binder concentration and an excessive fine particles content for the binder concentration in the vicinity of its surface than in the vicinity of the interface with the base. As a result, the coating film suffers from surface unevenness due to the fine particles compared with a film formed of the same coating composition but by rapid drying. Such a coating film would have poor surface conditions when further coated with another coating. The lowered binder concentration in the surface makes the film weaker and less adhesive to another coating if applied thereon.

It has therefore been pointed out that the rate of solvent evaporation from the coating film should be controlled optimally so as not to create coating unevenness. In order to prevent mottle formation in drying an applied coating, JP-B-2-58554 (U.S. Pat. No. 4,365,423) proposes isolating a coating from a surrounding air flow, specifically by disposing a flat metal plate or a metal screen near the coated surface, so that the coating may not be disturbed by drying air or steep solvent evaporation in drying immediately after coating.

### SUMMARY OF THE INVENTION

Nevertheless there still is the problem where a coating composition has a higher solvent content for a binder content, i.e., a low solid concentration. Because the solvent penetrates into a CTA base at a high rate, the solid matter accompanying the penetrating solvent readily results in an uneven distribution in the thickness direction to such a degree that adversely affects the essential function of the coating film. Part of the fine particles and the binder can penetrate into the CTA base together with the solvent, resulting in reduction of binder concentration in the dried coating film. A reduced binder concentration can reduce the film thickness. When another coating is applied to the resulting film, a reduced binder concentration in the surface impairs adhesion to another coating. Besides, the resulting film can suffer from fine surface roughness, which also deteriorates coating properties when another coating is applied thereon.

Where in particular a coating film is required to have highly elaborated surface conditions in precision and uniformity as in use as an optical film, the technique of JP-B-2-58554 cannot get rid of the following problem. If drying immediately after coating is carried out while isolating the coated surface from surrounding air flow so as to protect against turbulence due to drying air or abrupt solvent evaporation, the drying speed reduces. This adds to the penetration problem especially where the coating composition has a higher solvent content for the solid content, often resulting in surface roughness or unevenness.

An object of the present invention is to provide a method of drying a liquid coating composition containing an organic solvent that has been applied to a CTA base, in which the coating composition is prevented from penetrating into the CTA base thereby to reduce changes in coating surface conditions (formation of surface roughness, etc.) and reduction of film strength.

The above object of the invention is accomplished by a method of drying a liquid coating composition comprising a volatile solvent and a binder applied to a base film containing CTA, wherein drying of the coated base film is started within 10 seconds from coating, and the residual solvent content of the coating is reduced to 30% or less based on the binder within 30 seconds from coating.

The drying method of the present invention embraces preferred embodiments; in which

the drying of the coated base film includes drying the side of the base film opposite to the coated side;

the drying of the coated base film is carried out by radiant heating;

the drying of the coated base film is carried out by bringing the base film into contact with a conductive heater;

the drying of the coated base film includes drying the coated side of the base film by blowing air thereto; and

the liquid coating composition is applied to the base film in an amount of 10 ml/m² or less.

The present invention has been reached based on the following background. A coating composition mainly comprises a polymeric or monomeric film-forming binder. It can additionally contain a crosslinking agent, a reaction initiator accelerating heat- or light-induced curing, fine particles (smaller than several micrometers) of an organic polymer (e.g., polystyrene or polymethyl methacrylate) or an inorganic substance (e.g., silica), and ultrafine (1 μm or smaller) inorganic particles. That is, a liquid coating composition has these components dissolved or dispersed in a few kinds of solvents. The binder serves to uniformly disperse the particulate components in the coating applied and, after drying, immobilize the components. The binder must be present in a proportion sufficient for achieving the purposed function of a coating film and, in particular, for uniformly dispersing and immobilizing the particulate components. Therefore, a coating composition is prepared by using the binder in a proportion previously and accurately determined according to the purpose. If the binder content is below the predetermined one, the coating may have difficulty in immobilizing and fixing the particles or, after being dried, results in a reduced film thickness, failing to exert the necessary function. If the binder is used in an increased amount in an attempt to compensate for the loss due to penetration into a CTA substrate, the coating composition will have an increased viscosity, which deteriorates the coating properties. Even where the coating composition with an increased viscosity could be successfully applied, it is very difficult for some of the components to penetrate into a CTA substrate uniformly. This can cause variation of film thickness or formation of exaggerated surface profile of the film, resulting in a failure to fulfil the desired function uniformly.

As a result of investigation into these phenomena, the inventors have revealed that the binder dissolved in an organic solvent penetrates into a CTA base accompanying the solvent penetrating into the CTA base. They have then studied whether the outstanding problem could be solved by optimizing the rate of evaporation of the coating. In the course of their study, the inventors have ascertained that the rate of solvent penetration into a CTA base steeply rises after several seconds from coating and that the penetration at such high rate continues thereafter. When, for instance, the solvent system contains MEK as a main solvent component, and the base film has a thickness of 40 to 200 μm, such rapid penetration continues for about 30 seconds. The rate of solvent penetration is higher at a higher residual solvent content in the coating film and becomes lower with a decrease of the residual solvent content. When the residual solvent to binder ratio reduces to 30% or smaller, the rate of binder penetration becomes extremely low to eliminate the above-mentioned problem. The inventors have thus reached the finding that the solvent penetration into a CTA base could be reduced to an unproblematic level by starting a drying treatment within about 10 seconds from coating and reducing the residual solvent content to about 30% based on the binder within 30 seconds from coating.

Based on this finding, the inventors have succeeded in minimizing binder penetration into a CTA base film thereby to make the resulting coating film exhibit its essential function by starting drying as soon as possible, specifically within about 10 seconds from coating, and reducing the residual solvent to binder ratio in the coating film to 30% or lower within 30 seconds from coating.

### BRIEF DESCRIPTION OF THE DRAWINGS

FIG. 1 schematically illustrates a typical system for coating and drying a photocuring liquid coating composition on a base.

FIG. 2 (FIGS. 2A and 2B) shows radiant heaters, in which (A) is a structure using a ceramic material under heat control, and (B) is a structure having infrared heating elements under control.

FIG. 3 graphically represents an example of change in quantity of heat supplied to a base per unit time in the first drying zone and resultant change in residual solvent content in the coating applied.

### DETAILED DESCRIPTION OF THE INVENTION

The present invention will be described in detail based on its preferred embodiments with reference to the accompanying drawings.

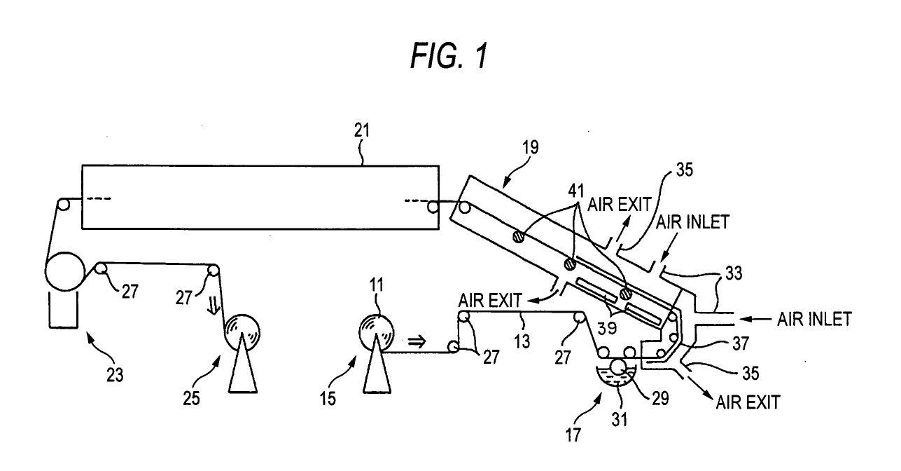

FIG. 1 schematically illustrates a typical system for coating and drying a photocuring liquid coating composition on abase. The coating and drying system 100 has a base feeding unit 15 in which a base 13 is unwound from a stock roll 11, a coating unit 17 in which a liquid coating composition 31 is applied to the base 13, a first drying zone 19 for controlling penetration into the base 13, a second drying zone 21 for removing a residual solvent, a UV irradiation unit 23 for irradiating with ultraviolet light for photocuring, and a take-off unit 25 for taking up the coated base into roll.

Feed rollers 27 are placed at appropriate positions to provide a path for the base 13 coming from the base feeding unit 15. In the coating unit 17 the coating 31 is applied to one side of the base 13 with a gravure coating roll 29. In addition to gravure coating (including reverse roll coating), coating methods of option include roll coating, bar coating, and extrusion coating. The base 13 from the stock roll 11 is coated with the coating (liquid coating composition) 31 in the coating unit 17 and then transported into the first drying zone 19.

The first drying zone 19 is for carrying out an initial drying step in which the coating is dried immediately after it is applied in the coating unit 17. The first drying zone 19 has air inlet ducts 33 and air exit ducts 35 for supplying drying air. The inlet ducts 33 are mostly above the coated side of the traveling base. The exit ducts 35 may be provided either above or below the base. While traveling in the first drying zone 19, the coated base is heated by a heating unit from the side opposite the coating film (the side opposite the coating film will be referred to as a back side) to promote drying. A shield 37 made of a metal plate or a metal screen is provided above and near the coated side of the base 13 over a predetermined length along the path of the base 13. The shield 37 functions to suppress abrupt drying of the coating film immediately after coating. The distance from the coating film surface to the shield 37 is preferably about 3 to 50 mm. The length of the shield 37 is preferably up to about 20 m, while depending on the coating rate, etc.

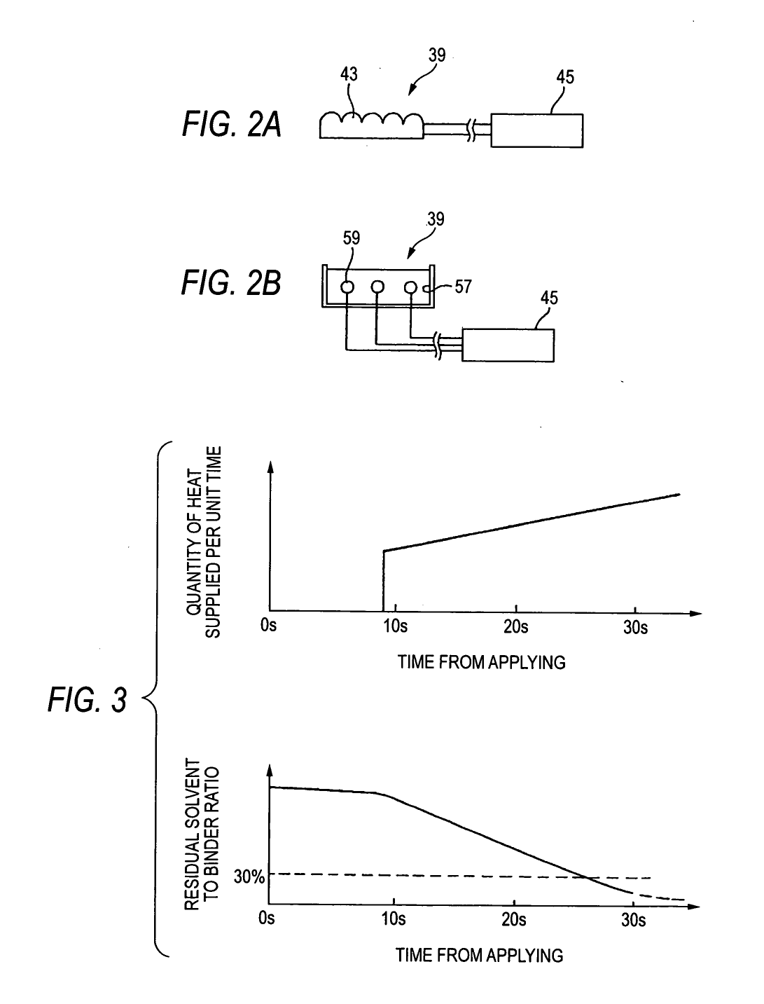

The heating unit is composed of radiant heaters 39 and conductive heaters 41. The radiant heaters 39 are located in the side of the back side of the traveling base 13 to heat the base 13 with radiant heat. The conductive heaters 41 are installed in contact with the back side of the traveling base 13 to heat the base 13. The radiant heater 39 includes a ceramic heater as shown in FIG. 2A, in which the heat of an electrothermally heated ceramic material 43 is controlled by a controller 45, and an infrared heater as shown in FIG. 2B, in which the heat of an infrared heating element 59 enclosed in a box having reflector walls 57 is controlled by a controller 45.

The conductive heater 41 includes a heating roll having therein hot water as shown in FIG. 1. Plate heaters with a smooth sliding surface are also employable as a conductive heater.

The coated base 13 having passed through the first drying zone 19 is forwarded into the second drying zone 21, where the residual solvent is removed, and further transferred to the UV irradiation unit 23, where it is irradiated with photocuring ultraviolet light. The coated base 13 having been thus dried is wound into roll in the take-off unit 25.

The liquid coating composition which can be used in the invention is not particularly limited. It usually has a solid concentration of 0.01 to 80% by weight and a viscosity of 0.1 to 20 cP. The solvent type binder may be either monomeric or polymeric. Monomeric binders include compounds having at least two ethylenically unsaturated groups per molecule, such as esters between polyhydric alcohols and (meth)acrylic acid (e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate dipentaerythritol penta(meth)acrylate, dipentaerythritol, hexa(meth)acrylate, 1,2,3-cyclohexane tetramethacrylate, polyurethane polyacrylate, and polyester polyacrylate), vinylbenzene and its derivatives (e.g., 1,4-divinylbenzene, 2-acryloylethyl 4-vinylbenzoate, and 1,4-divinylcyclohexanone), vinylsulfones (e.g., divinylsulfone), and (meth)acrylamides (e.g., methylenebisacrylamide).

A compound having a crosslinkable functional group may be used in place of, or in addition to, the monomer having at least two ethylenically unsaturated groups. Examples of crosslinkable functional groups are isocyanato, epoxy, aziridine, oxazoline, aldehyde, carbonyl, hydrazine, carboxyl, methylol, and active methylene groups. Compounds having such a crosslinkable group can also have a group derived from vinylsulfonic acid, an acid anhydride, a cyanoacrylate derivative, melamine, etherified methylol, ester, urethane or a metal alkoxide (as, e.g., in tetramethoxysilane) or a blocked isocyanate group. Where a compound with a crosslinkable group is used, it is necessary to crosslink the binder by heat coating, etc. after coating. Additionally, bis(4-methacryloylthiophenyl) sulfide, vinylnaphthalene, vinylphenyl sulfide, 4-methacryloxyphenyl-4′-methoxyphenyl thioether, etc. are also useful.

The coating composition can contain a crosslinking agent, a reaction initiator that accelerates heat- or light-induced curing, fine organic or inorganic particles of several micrometers, ultrafine inorganic particles of not greater than one micrometer, and so forth. The ultrafine inorganic particles include oxides of titanium, aluminum, indium, zinc, tin, antimony or zirconium having a particle size of 100 nm or smaller, preferably 50 nm or smaller. Such ultrafine oxides include TiO₂, Al₂O₃, In₂O₃, ZnO, SnO₂, Sb₂O₂, ITO, and ZrO₂. A preferred content of the ultrafine inorganic particles in the coating composition is 10 to 90% by weight, particularly 20 to 80% by weight.

The coating composition can further contain fine inorganic or polymeric particles having a particle size of 10 μm or smaller. The fine inorganic particles include silica beads. The fine polymeric particles include polymethyl methacrylate beads, polycarbonate beads, polystyrene beads, polystyrene-acrylate beads, and silicone beads.

The polymeric binders include crosslinkable fluoropolymers, such as perfluoroalkyl-containing silane compounds (e.g., (heptadecafluoro-1,1,2,2-tetradecyl)triethoxysilane) and fluorocopolymers composed of a fluoromonomer unit and a monomer unit serving for introducing a crosslinking group.

Examples of the fluoromonomers are fluoroolefins (e.g., fluoroethylene, vinylidene fluoride, tetrafluoroethylene, hexafluoroethylene, hexafluoropropylene, perfluoro-2,2-dimethyl-1,3-dioxonol), (meth)acrylic acid alkyl ester derivatives with the alkyl moiety partially or completely fluorinated (e.g., Viscoat 6FM, available from Osaka organic Chemical Industry Ltd., and M-2020, available from Daikin Industries, Ltd.), and partially or completely fluorinated vinyl ethers.

Monomers serving for introducing a crosslinking group include (1) (meth)acrylates having a crosslinking functional group, such as glycidyl methacrylate, in the molecule and (2) (meth)acrylates having a carboxyl group, a hydroxyl group, an amino group, a sulfo group, etc. (e.g., (meth)acrylic acid, methylol (meth)acrylate, hydroxyalkyl (meth)acrylate, and allyl acrylate). It is known that a crosslinked structure can be introduced after copolymerization of the monomer unit (2) as taught in JP-A-10-25388 and JP-A-10-147739.

Copolymers having not only the fluoromonomer unit but a monomer unit containing no fluorine atom are also useful.

Monomer units that can be used in combination with the fluoromonomer include olefins (e.g., ethylene, propylene, isoprene, vinyl chloride, and vinylidene chloride), acrylic esters (e.g., methyl acrylate, ethyl acrylate, and 2-ethylhexyl acrylate), methacrylic esters (e.g., methyl methacrylate, ethyl methacrylate, butyl methacrylate, and ethylene glycol dimethacrylate), styrene derivatives (e.g., styrene, divinylbenzene, vinyltoluene, and α-methylstyrene), vinyl ethers (e.g., methyl vinyl ether) vinyl esters (e.g., vinyl acetate, vinyl propionate, and vinyl cinnamate), acrylamides (e.g., N-t-butylacrylamide and N-cyclohexylacrylamide), methacrylamides, and acrylonitrile derivatives.

Alcohols and ketones are mainly used as a solvent of the coating composition. Typical examples of alcohol solvents are methanol, ethanol, propanol, isopropyl alcohol, and butanol. Typical examples of ketone solvents are methyl ethyl ketone (MEK), methyl isobutyl ketone, and cyclohexanone. Toluene, acetone, etc. are also usable. These solvents can be used either individually or as a mixture thereof.

The method of drying a liquid coating composition, featuring drying by heating the base 13 in the first drying zone 19, will be described in detail.

FIG. 3 graphically represents an example of change in quantity of heat supplied to a base per unit time in the first drying zone and resultant change in residual solvent content in the coating having been applied.

In this particular example, the system is configured to start heating in the first drying zone 19 within 10 seconds from applying the coating 31 to the base 13 and to reduce the residual solvent to binder ratio in the applied coating to 30% or less within 30 seconds from the coating. To achieve this, at least one heating member selected from the radiant heaters 39 and the conductive heaters 41 is located at a position where the base 13 can reach within 10 seconds after it passes on the gravure roll 29. Heat is thus supplied by the heating member within 10 seconds after coating, and the heat quantity received by the base 13 increases thereafter as shown in FIG. 3. In spite of the presence of the shield 37 which suppresses evaporation of the solvent, the evaporation rate of the residual solvent approaches a level that would be reached in the absence of the shield 37 or the first drying zone 19. The residual solvent to binder ratio can be reduced to 30% or less by the time when 30 seconds lapse from the coating. The quantity of heat supplied after 10 seconds from the coating may be either constant or gradually increased. Gradual increase in heat quantity supplied results in accelerated drying of the coating and shortening of the drying time. Such a heating pattern is designed by properly adjusting the amounts of heat generation or the positions of the radiant heaters 39 and the conductive heaters 41.

By use of the radiant heaters 39, a large quantity of heat from high temperature heat sources can be supplied to the base 13 efficiently. By use of the conductive heaters 41, the base 13 can be heated rapidly through direct heat conduction.

The above-described configuration facilitates control on solvent penetration in CTA thereby to prevent the binder from penetrating together with the solvent and leaving solid particles behind, which otherwise tend to come off to deteriorate adhesion of the coating film to another layer and to generate fine surface roughness.

The following is an illustrative example presenting coating and drying (back side heating) conditions according to the method of the invention.

Coating Conditions:

The base is coated at a rate of 20 ml/m² or less, preferably 10 ml/m² or less. The improvement on coating film properties provided by the invention is particularly remarkable when the coating rate is 10 ml or less. The solvent on which the present invention is especially effective includes MEK, acetone, cyclohexanone, methyl acetate, and ethyl acetate, which are more liable to penetrate than others. As a matter of course, the drying method of the invention is effective on coating compositions containing an alcohol, toluene, methyl isobutyl ketone or a like solvent that are less penetrable to bring about improvement in coating film properties. The coating speed is 100 m/min or lower. The temperature of the coating composition is 15° to 35° C. The coating atmosphere has a temperature of 15° to 30° C., preferably 20° to 28° C., and a relative humidity of 75% or less, preferably 65% or less.

Drying Conditions:

(1) Up to 30 Seconds From Coating

The supplied air temperature is up to 100° C., preferably 50° C. or lower. The air velocity is up to 5 m/sec, preferably 1 m/sec or lower. A metal screen of 50 to 500 mesh (number of wires per inch) is installed as a shield about 3 to 50 mm above the coating film, and air is supplied through the screen. The above-recited air velocity is the value measured between the screen and the coating film.

(2) After 30 Seconds From Coating and Later

The air temperature is 150° C. at the highest. The air velocity is up to 20 m/sec.

In (1) and (2) above, the dew point of the drying air is set at 20° C. or lower, and drying may be effected only by heating without air blowing.

Back Side Heating Conditions:

The heating rolls (conductive heaters) have a diameter of 50 to 300 mm, preferably 50 to 150 mm. They are disposed along the path of the base at a pitch within 1 m, preferably 100 to 500 mm, which varies depending on the roll diameter. The heating rolls have a metal surface or a resin (e.g., Teflon) coated surface with a surface roughness of 0.8S or smaller, preferably 0.3S or smaller.

### EXAMPLES

The present invention will now be illustrated in greater detail with reference to Examples and Comparative Examples.

### Examples 1 to 4 and Comparative Examples 1 to 4

(In Examples 1 to 4 and Comparative Example 2, there is a shield, air inletting is not done, and air exiting is done, in Comparative Examples 1 and 4, there is no shield, air inletting is done (warm air blown to coated side), and air exiting is done, and in Comparative Example 3, there is no shield, air inletting is not done, and air exiting is done)

1) Preparation of Coating For Lower Layer

To a mixed solvent of 104.1 g of cyclohexanone and 61.3 g of MEK was added while agitating in an air disperser 217.0 g of a coating composition for hard coat containing a zirconium oxide (particle size: about 30 nm) dispersion KZ-7991 (available from JSR Corp.). To the dispersion was added 5 g of crosslinked polystyrene beads SX-200H (average particle size: 2 μm; available from Soken Chemical & Engineering Co., Ltd.), and the mixture was dispersed in a high speed disperser at 5000 rpm for 1 hour, followed by filtering through a polypropylene filter having a pore size of 30 μm to prepare a coating for lower layer.

2) Preparation of Coating For Upper Layer

To 2.00 g of a thermally crosslinking fluoropolymer having a refractive index of 1.46 (JN-7221, available from JSR Corp.) was added 200 g of methyl isobutyl ketone. After stirring, the mixture was filtered through a polypropylene filter having a pore size of 1 μm to prepare a coating for upper layer.

3) Formation of Lower Layer

A CTA base film having a thickness of 80 μm (TAC-TD80U, available from Fuji Photo Film Co., Ltd.) was coated with the coating for lower layer by means of a bar coater. The coating applied to the CTA base was dried at 120° C. under the conditions shown in Table 1 below and irradiated with ultraviolet light of a 160 W/cm air-cooled metal halide lamp (available from Eye Graphics Co., Ltd.) at an illuminance of 400 mW/cm² and a UV dose of 300 mJ/cm² to cure the coating to form a lower layer having a thickness of about 1.5 μm. In Examples 1 to 4 and Comparative Examples 2 and 3, air was not blown to the coating layer in the drying step, just being let out from the drying zone. Though, for examples, there are air exit ducts at both side of the coating layer and the base in FIG. 1, the letting out can be done by either one or both of the ducts (position of ducts are not be limited). By the letting out, (relatively concentrated) air including the evaporated solvent positioned at a portion between the coating layer and a shield 37 can be let out.

4) Formation of Upper Layer

The coating for upper layer was applied on the lower layer with a bar coater, dried at 80° C., and heat-treated at 120° C. for 10 minutes to induce crosslinking to form a 0.096 μm thick upper layer.

5) Evaluation

Before forming the upper layer, the surface of the lower layer formed on the CTA base was observed under a scanning electron microscope, and the surface roughness was rated A (satisfactory), B (slightly rough), C (rough) or D (very rough). The visual unevenness of the surface was also observed.

An adhesive tape was stuck to the upper layer and stripped off. The adhesion of the lower layer to the upper layer was evaluated from whether or not the upper layer was peeled together with the adhesive tape.

The results of evaluation are shown in Table 1.

TABLE 1

| | | | Time for | | | | |
|---|---|---|---|---|---|---|---|
| | | | Reducing | | | | |
| | Heating | | Residual | | | | |
| | Starting | | Solvent to | | | | |
| | Time after | | Binder Ratio | Air Blowing | Coating | Coating | |
| | Coating | | to 30% or less | to Coating | Surface | Surface | Adhesion to |
| | (sec) | Heating Mode | (sec) | Layer | Roughness | Unevenness | Upper Layer |
| Example 1 | 4 | heating rolls | 19 | no | A | no | good |
| | | (Ø100 mm; 300 mm | | | | | |
| | | pitch) | | | | | |
| Example 2 | 5 | ceramic heater | 20 | no | A | no | good |
| Example 3 | 10 | heating rolls | 30 | no | A | no | good |
| | | (Ø100 mm; 300 mm | | | | | |
| | | pitch) | | | | | |
| Example 4 | 10 | infrared heater | 30 | no | A | no | good |
| Comp. | 12 | warm air blown to | 30 | air | B | slight | partial peel |
| Example 1 | | coated side | | velocity = 1 m/s; | | | of upper |
| | | | | 50° C. | | | layer |
| Comp. | 12 | heating rolls | 35 | no | C | no | complete |
| Example 2 | | (Ø100 mm; 300 mm | | | | | peel of |
| | | pitch) | | | | | upper layer |
| Comp. | 15 | none | 35 | no | D | no | complete |
| Example 3 | | | | | | | peel of |
| | | | | | | | upper layer |
| Comp. | 3 | warm air blown to | 20 | air | A | heavy | good |
| Example 4 | | coated side | | velocity = 0.5 m/s; | | | |
| | | | | 50° C. | | | |

In Examples 1 to 4 in which heat drying of the lower coating layer was started within 10 seconds from coating, and the residual solvent to binder ratio was reduced to 30% or less within 30 seconds from coating, the lower layer had reduced surface roughness, no surface unevenness, and satisfactory adhesion to the upper layer as shown in Table 3. In contrast, in Comparative Examples 1 to 3 where heat drying was initiated after more than 10 seconds from the coating, the coating film suffered from surface roughening and exhibited poor adhesion to the upper layer (the upper layer was peeled off partially or completely). In Comparative Example 4 in which drying was carried out by starting blowing warm air against the coated side of the base within 10 seconds from the coating with no back side heating, the lower layer had reduced surface roughness and good adhesion to the upper layer. However, the lower layer suffered from surface unevenness, which proves the importance of back side heating. The surface conditions of the upper layer were equal to those of the respective lower layer in each of Examples and Comparative Examples.

According to the drying method of the invention, drying of a liquid coating composition containing a volatile solvent having been applied to a base film containing cellulose triacetate can be accomplished while minimizing penetration of the binder into the base film by starting drying within 10 seconds from the coating and reducing the residual solvent to binder ration of the coating film to 30% or less within 30 seconds from the coating. As a result, formation of surface roughness and unevenness can be prevented, and the dried coating film exhibits improved adhesion to another coating layer.

This coating is based on Japanese Patent coating JP 2003-33796, filed Feb. 12, 2003, the entire content of which is hereby incorporated by reference, the same as if set forth at length.

What is claimed is:

1. A method comprising: drying a liquid coating composition containing a volatile solvent and a binder coated to a base film containing cellulose triacetate, wherein drying of the coatedbase film is started within 10 seconds from coating, and a residual solvent content of the coating is reduced to 30% or less based on the binder within 30 seconds from coating.

2. The method according to claim 1, wherein the drying of the coated base film includes heating a side of the base film opposite the coated side.

3. The method according to claim 2, wherein the heating is carried out by using radiant heat from a radiant heater.

4. The method according to claim 2, wherein the heating is carried out by bringing the base film into contact with a conductive heater.

5. The method according to claim 1, wherein the liquid coating composition is coated to the base film in an amount of 10 ml/m² or less.

6. The method according to claim 2, wherein the liquid coating composition is coated to the base film in an amount of 10 ml/m² or less.

7. The method according to claim 3, wherein the liquid coating composition is coated to the base film in an amount of 10 ml/m² or less.

8. The method according to claim 4, wherein the liquid coating composition is coated to the base film in an amount of 10 ml/m² or less.
